(19) United States
(12) Patent Application Publication
(10) Pub. No.: US 2007/0275869 A1
(43) Pub. Date: Nov. 29, 2007

(54) Polysaccharide Derivatives, Their Production and Use

(75) Inventors: Hans-Ullrich Hoppe, Langenbach (DE); Hans Henning Wenk, Essen (DE)

Correspondence Address: Millen, White, Zelano & Branigan, Arlington Courthouse Plaza 1, 2200 Clarendon Boulevard, Suite 1400, Arlington, VA, 22201, US

(73) Assignee: BIOGHURT BIOGARDE GMBH & CO., KG, FREISING, GERMANY (DE)

(21) Appl. No.: 10/581,750

(22) PCT Filed: Dec. 7, 2004
(86) PCT No.: PCT/EP04/13904

§ 371 Date: Apr. 16, 2007

(30) Foreign Application Priority Data
Dec. 8, 2003 (DE) 103-57-260.0

(51) Int. Cl. C08B 37/00; C08B 37/14

(52) U.S. Cl. 510/515; 536/30; 536/53

(57) ABSTRACT

The invention relates to polysaccharide derivatives consisting of a biopolysaccharide skeleton and organic groups with a molecular weight <5 000 that are connected to said skeleton via ether bridges. The organic groups have the general formula (Ia) or (Ib). Preferably, α- or β-(1,4)- and/or α or β-(1,3)-glucan units are used as the biopolysaccharide component, such as e.g. xy-loglucans, glucomannans such as guar gum or locust bean gum, xanthan gum, carrageenans, alginates and pectins. The invention also relates to a method for producing said polysaccharide derivatives, according to which the biopolysaccharide component is reacted with an N-alkyl maleamic acid or a salt thereof in the presence of a base catalyst, whereby the maleamide component can also be cyclised prior to or following the reaction with the biopolysaccharide component. A wide variety of polysaccharide derivatives can thus be obtained, said derivatives being especially suitable for bonding to cellulose fibres, a fact that is of particular interest for the treatment of textiles and that makes the inventive polysaccharide derivatives particularly suitable as bio-degradable fabric softeners.

The present invention relates to biopolysaccharide derivatives bound to organic radicals, a method for production thereof and use thereof.

Polysaccharides having specific side chains which are capable, in particular, of binding to cellulose substrates are sufficiently known from the prior art.

For instance, International Patent Application WO 99/36469 describes polysaccharide conjugates which consist of a polysaccharide main chain to which radicals having a molecular weight of at least 5000 are bound, as a result of which the polysaccharides are capable of binding to cellulose.

Well known in this context is also the property of naturally occurring polysaccharides, for example xyloglucans from peas or tamarind seed, of binding to cellulose via polysaccharide-polysaccharide interactions. This type of binding is known especially from plant cell walls, but it also serves to give cellulose fibers special properties, for example in the paper and textile industries.

In addition to the derivatization of natural poly-saccharides with relatively large side groups, attempts have also been made to derivatize biopolymers using carbonyl-bearing radicals of lower molecular masses.

U.S. Pat. No. 3,297,604 describes polymer compositions which contain galactose units in oxidized form, their carbonyl groups reacting to form cyanohydrins, disulfite-addition compounds, oximes, or hydrazones. The compositions described in this document can also be used for crosslinking polymers, for example guar gum, locust bean gum, and in particular cellulose.

The publication by Hayashi et al. (“Pea Xyloglucan and Cellulose” in Plant Physiol. 1987, 83, 384-389) describes studies on the binding behavior of pea xyloglucans to cellulose, with the xyloglucan having been treated with CNBr and fluoresceinamine. The radicals mentioned in this publication are still the smallest molecular units which have been hitherto linked to polysaccharides.

On the basis of the prior art, for the present invention the object set is to provide polysaccharide derivatives consisting of a biopolysaccharide backbone and organic radicals bound thereto which are able to bind to cellulose units and which are in particular biodegradable and thus especially, from an industrial aspect, are an ecologically and economically rational alternative to the previously known treatment agents of cellulose fibers.

These novel polysaccharide derivatives should be able to be produced using a method as simple as possible and using ecologically harmless starting compounds and be suitable in particular for environmentally sensitive fields of application.

This object was achieved by corresponding polysaccharide derivatives consisting of a biopolysaccharide backbone and organic radicals having a molecular weight <5000 bound thereto via ether bridges.

Surprisingly, it has been found that the inventive polysaccharide derivatives not only may be produced in accordance with the objective from conventional and extremely environmentally acceptable starting compounds in a simple manner, but that they are also outstandingly suitable for conjugation to cellulose fibers which was hitherto only known of corresponding polysaccharide compounds which have organic radicals having a molecular weight of at least 5000. In contrast to the known polysaccharide derivatives, the poly-saccharide derivatives of the invention avoid steric problems which occur in particular in the treatment of cellulosic textile fabrics.

In addition, the organic radicals bridged by the biopolysaccharide backbone can be modified to different extents by corresponding simple post-treatment methods, which additionally extends the field of use of the proposed polysaccharide derivatives.

With regard to the organic radicals, the present invention provides that these expediently have a molecular weight of 200 to 4000. The organic radicals preferably contain at least one carboxylic acid (salt) or carboxylic ester group and/or at least one carboxamide group, in particular a carboxylic acid C₆₋₂₄-alkylamide group. Particular preference is given to organic radicals which are bound to the biopolysaccharide via an ether bridge in the a-position to a carboxylic acid (salt) or carboxylic ester group or to a carboxamide group. Particular preference is given to organic radicals which have the general formulae (Ia) or (Ib) 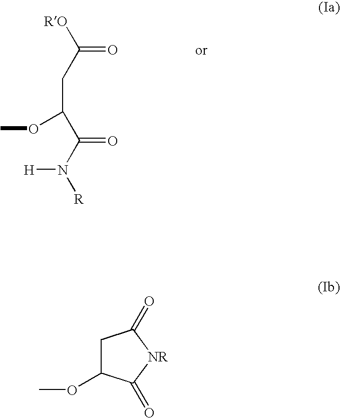
where R is a C₆₋₂₄-alkyl radical. This radical R in this case is especially a natural fatty acid radical and can if appropriate contain one or more double bonds. R′ is H, a C₁₋₃₀-alkyl radical or a cation, such as a metal (e.g. Na, K, etc.), an ammonium group, or an organic cation.

With respect to the biopolysaccharide component, according to the invention it is provided that this preferably consists of α- or β-(1,4)- and/or α- or β-(1,3)-glucan units, particularly preferably glucan, mannan and/or xylan units, and most preferably of glucose, mannose, xylose, galactose, guluronic acid, mannuronic acid and/or galacturonic acid units.

The symbol −O is an O atom which originates from the backbone of the biopolysaccharide component.

Particularly good properties, in particular with respect to biodegradability, are possessed by polysaccharide derivatives which according to the invention contain, as biopolysaccharide backbone, xyloglucan, glucomannan, mannan, galactomannan, α- or β-(1,3),(1,4)-glucan, glucurono-, arabino- or glucuronoarabinoxylan and, in particular, guar gum, locust bean gum, xanthan gum, carrageenan, alginates, pectin, starch, cellulose and any derivatives thereof, such as methyl, carboxymethyl, hydroxyalkyl, ethylene glycol and/or propylene glycol derivatives.

Especially polysaccharide derivatives which contain, as backbone, hydrocolloids such as galactomannans, bind surprisingly rapidly and effectively to cellulose units.

Overall, the biopolysaccharide component, in the context of the invention, is not subject to any restriction, but it is advisable to select representatives which have a minimum chain length of 4 sugar units.

The number of organic radicals per monosaccharide unit can be varied broadly within the context of the present invention and is preferably 0.01 to 4.

In addition to the polysaccharide derivatives themselves, the present invention also claims a method for production thereof, in which the biopolysaccharide is reacted under base catalysis with a suitable reagent for introducing the organic radical, preferably with N-alkylmaleamic acid or a salt thereof. The maleamic acid is to have an alkyl radical having 6 to 24 carbon atoms. Other suitable reagents are organic compounds having a C═C double bond which can react with OH groups of the biopolysaccharide forming an ether group, such as acrylic acid and derivatives thereof.

Preferably, for the inventive method, it is provided that N-alkylmaleamide has been obtained from a fatty acid amine of the general formula R—NH₂, where R=C₆₋₂₄-alkyl, and maleic anhydride.

The present invention also comprises a method variant in which the maleamide component has been cyclized to the maleimide derivative before the actual reaction with the biopolysaccharide.

Alternatively, the maleamide component according to the present invention can also be cyclized to the succinimide derivative after the reaction with the biopolysaccharide.

Finally, the invention also comprises a variant in which the carboxylic acid function of the maleamide component is esterified, for which an alcohol R′OH where R′=C₁₋₃₀-alkyl is particularly recommended. This esterification step can be performed not only before, but also after, the reaction with the biopolysaccharide.

To obtain the polysaccharide derivative in the desired quality, after addition of the organic radical to the biopolysaccharide backbone has been performed, it can be precipitated out, for which preferably a mineral acid, for example a dilute hydrochloric acid, is used.

In principle, the described production of N-substituted maleamide acids and maleimides from amines and maleic anhydride follows the known synthesis protocols, as are known, for example, from Organic Synthesis, Coll. Vol. IV, 944. The addition of alcohols to maleamic esters or maleamides is known, e.g., from R. A. Finnegan and W. H. Mueller, J. Pharm. Sci. 1965, 54, 1257-1260.

The present invention likewise comprises the use of the inventive polysaccharide derivatives for binding to cellulose fibers. Preferably, the use takes place in the context of the invention for textile treatment, and particularly preferably as biodegradable fabric softener.

In summary, the present invention is focused on polysaccharide derivatives which, as backbone, have a biopolysaccharide having α- or β-(1,4)- and/or α- or β-(1,3)-glucan units and which are bound via ether bridges to organic radicals which have a molecular weight <5000. Since not only the biopolysaccharides, but also the organic radicals preferably bound thereto, are naturally occurring compounds and toxicologically harmless compounds, the inventive polysaccharide derivatives are readily biodegradable products which, in particular from ecological aspects, also pose no problems in the industrial field of use, e.g. textile preparation and processing.

The example hereinafter illustrates the advantages of the present invention, in particular with respect to producing the claimed polysaccharide derivatives.

### EXAMPLE

4.0 g of maleic anhydride and 10.8 g of octadecylamine were dissolved in 40 ml of DMSO and stirred at 80° C. for 1 h. Then 6.0 g of potassium hydroxide were slowly added to the mixture and dissolved with stirring. 4.9 g of guar gum were added to this solution and the mixture was heated at 120° C. for 1 h with stirring. Finally, the mixture was cooled to room temperature and the product was neutralized and precipitated with dilute hydrochloric acid and ethanol.

1. A polysaccharide derivative consisting of a bio-polysaccharide backbone and organic radicals having a molecular weight <5000 bound thereto via ether bridges, in which the organic radicals have the general formulae (Ia) or (Ib) 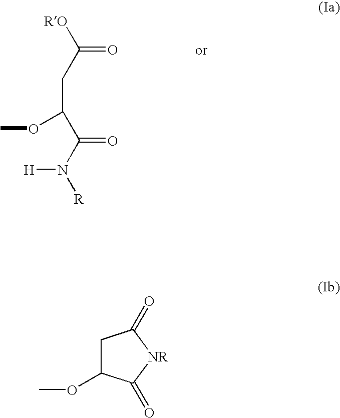
where R is a C₆₋₂₄-alkyl group and R′ is H, a C₁₋₃₀-alkyl radical or a cation.

2. The polysaccharide derivative as claimed in claim 1, characterized in that the biopoly-saccharide consists of α- or β-(1,4)- and/or αa- or β-(1,3)-glucan units.

3. The polysaccharide derivative as claimed in claim 1, characterized in that the biopoly-saccharide has glucose, mannose, xylose, galactose, guluronic acid, mannuronic acid and/or galacturonic acid units.

4. The polysaccharide derivative as claimed in claim 1, characterized in that the biopoly-saccharide is a xyloglucan, glucomannan, mannan, galactomannan, α- or β-(1,3),(1,4)-glucan, glucurono-, arabino- or glucuronoarabinoxylan and, in particular, guar gum, locust bean gum, xanthan gum, carrageenan, alginates, pectins, starch, cellulose and derivatives thereof.

5. A method for producing a polysaccharide derivative as claimed in claim 1, characterized in that the polysaccharide is reacted under base catalysis with N-(C₆₋₂₄-)alkylmaleamic acid or a salt thereof, where optionally the carboxylic acid function of the maleamide component, before or after the reaction, is esterified with an alcohol R′—OH, where R′=C₁₋₃₀-alkyl.

6. The method as claimed in claim 5, characterized in that the N-alkylmaleamide has been obtained from a fatty acid amine of the general formula R—NH₂, where R=C₆₋₂₄-alkyl, and maleic anhydride.

7. The method as claimed in claim 5, characterized in that the maleamide component has been cyclized to the maleimide derivative before the reaction with the polysaccharide.

8. The method as claimed in claim 5, characterized in that the maleamide component is cyclized to the succinimide derivative after the reaction with the polysaccharide.

9. The method as claimed in claim 5, characterized in that the polysaccharide derivative, after addition of the organic radical has been performed, is precipitated out, preferably using a mineral acid.

10. The use of the polysaccharide derivative as claimed in claim 1 for binding to cellulose fibers.

11. The use as claimed in claim 10 for textile treatment.

12. The use as claimed in claim 10 as biodegradable fabric softener.
